(19) United States
(12) Patent Application Publication
(10) Pub. No.: US 2008/0193801 A1
(43) Pub. Date: Aug. 14, 2008

(54) Glass Substrate for Magnetic Recording Medium and Magnetic Recording Medium

(75) Inventors: Kazuyuki Haneda, Chiba (JP); Katsuaki AIDA, Chiba (JP); Hiroyuki Machida, Chiba (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Tokyo (JP)

(21) Appl. No.: 11/661,268

(22) PCT Filed: Aug. 30, 2005
(86) PCT No.: PCT/JP05/16194

§ 371 Date: Feb. 27, 2007

Related U.S. Application Data
(60) Provisional application No. 60/607,585, filed on Sep. 8, 2004.

(30) Foreign Application Priority Data
Aug. 30, 2004 (JP) 2004-250924

(51) Int. Cl. G11B 5/735

(52) U.S. Cl. 428/846.9

(57) ABSTRACT

A glass substrate for a magnetic recording medium, having a chamfer face between the surface (data face) of the substrate for forming thereon a film comprising a magnetic layer, and the outer peripheral end face (straight face) of the substrate, wherein the outer peripheral chamfer face has a dub-off of 120 Å or less in the radial direction.

### CROSS REFERENCE TO RELATED APPLICATION

This application is an application filed under 35 U.S.C. §111(a) claiming benefit pursuant to 35 U.S.C. §119(e) of the filing date of Provisional Application 60/607,585, filed on Sep. 8, 2004 pursuant to 35 U.S.C. §111(b).

### TECHNICAL FIELD

The present invention relates to a magnetic recording medium which is widely usable as a recording medium in various electronic devices (e.g., computer), and a glass substrate which is suitably usable as a substrate (or base material) for forming the above-mentioned magnetic recording medium.

### BACKGROUND ART

Heretofore, an aluminum substrate has been widely used as the substrate for magnetic recording mediums such as magnetic disk (e.g., hard disk). On the other hand, in recent years, various electric appliances such as small personal computer and portable audio-video recording/reproducing apparatus have been widespread. In addition, to cope with the tendency toward so-called light, thin, short and small weight, size or volume in these electric appliances, the demand for thinning, high-density recording and applicability in various use environments of a magnetic recording medium which is one of the important components constituting the electric appliance is more and more increasing.

In order to satisfy this severe requirement, a glass substrate having high impact resistance, rigidity/hardness and high chemical durability has come to be widely used in recent years. When such a glass substrate is used for a magnetic recording medium in the hard disk (HD) mode, this is generally advantageous also in that flatness suitable for low flying of the head on the magnetic recording surface, which is very important for realizing a high-density magnetic recording surface, can easily be obtained.

More specifically, in the field of substrate for a magnetic disk, thinning by the reduction in weight and mechanical properties such as rigidity high enough to endure rolling of the disk at high-speed rotation are required and at the same time, the demand for high-density recording is very strong. The flying height of the magnetic head with respect to the magnetic disk substrate is becoming extremely small so as to achieve high-density recording and for the purpose of achieving extremely small flying height, the magnetic disk substrate is required to have specular flatness or small surface roughness and at the same time, have least possible defects such as fine scratch and fine pit.

Generally, when the head flies above the disk, the head must be made to fly stably while keeping the head as close as possible to the disk. Unless the head is kept close to the disk in this manner, problems occurs in achieving high-speed recording/reading and high-density recording. The disk-head gap for making the head fly stably without contacting with the disk is called the “outer peripheral glide avalanche”. In order to obtain a desirable outer peripheral glide avalanche, a variety of chamfer shapes have been devised (Patent Document 1).

In recent years, because of the need for higher recording density, it is strongly demanded to further reduce the outer peripheral glide avalanche. However, when conventional glass substrates are used, it has been difficult to achieve such a small outer peripheral glide avalanche.

[Patent Document 1] Japanese Unexamined Patent Publication (JP-A; KOKAI) No. H05-1290365

### Disclosure of Invention

An object of the present invention is to provide a magnetic recording medium which can solve the above problem encountered in the prior art, and a glass substrate which is advantageously usable for such a magnetic recording medium.

Another object of the present invention is to provide a glass substrate for a magnetic recording medium which can achieve a small outer peripheral glide avalanche for achieving an increased density, and a magnetic recording medium using such a glass substrate.

As a result of earnest study, the present inventors have found that the provision of a specific dub-off to the outer peripheral chamfer face of a glass substrate is extremely effective in achieving the above object.

The glass substrate for a magnetic recording medium according to the present invention is based on the above discovery. More particularly, the glass substrate according to the present invention has a chamfer (chamfered) face between the surface (data face) of the substrate for forming thereon a film comprising a magnetic layer, and the outer peripheral (or circumferential) end face (straight face) of the substrate,

wherein the outer peripheral chamfer face has a dub-off of 120 Å or less in the radial direction.

The present invention also provides a magnetic recording medium, comprising: the above-mentioned glass substrate, and a magnetic recording layer disposed on the data face of the glass substrate.

The present invention includes, for example, the following embodiments.

(1) A glass substrate for a magnetic recording medium, having a chamfer (chamfered) face between the surface (data face) of the substrate for forming thereon a film comprising a magnetic layer, and the outer peripheral end face (straight face) of the substrate, wherein the outer peripheral chamfer face has a dub-off of 120 Å or less in the radial direction.

(2) A magnetic recording medium, comprising: a glass substrate according to the above item (1), and a magnetic recording layer disposed on the data face of the glass substrate.

When the magnetic recording medium or the glass substrate for the magnetic recording medium according to the present invention is used, a small preferred outer peripheral glide avalanche is provided. According to the knowledge of the present inventors, the reason therefor may be presumed as follows.

That is, in the case of the glass substrate for a magnetic recording medium in the prior art, it may be presumed that the head flying has become unstable because of the presence of a fine (or microscopic) protrusion (i.e., “ski jump”) or a fine sagging (i.e., “roll-off”) in the slope on the disk outer periphery, whereby a small preferred outer peripheral glide avalanche cannot be provided.

On the other hand, in the present invention, it may be presumed that any fine protrusion (ski jump) or fine sagging (roll-off) in the slope on the disk outer periphery can be suppressed or eliminated by providing the above-mentioned specific dub-off to the outer peripheral chamfer face of the glass substrate, and as a result, a small preferred outer peripheral glide avalanche can be provided.

### BRIEF DESCRIPTION OF DRAWINGS

FIG. 1 is a schematic perspective view and a schematic sectional view showing one basic embodiment of the glass substrate according to the present invention.

FIG. 2 is an enlarged schematic sectional view of the glass substrate of FIG. 1.

FIG. 3 is a schematic sectional view (a) (surface is located above the straight line joining r=29.9 and 31.5 (roll-off shape)) showing an example of Chord MAX (roll-off shape) and a schematic sectional view (b) (surface is located below the straight line joining r=29.9 and 31.5 (ski jump shape)) showing an example of Chord MIN (ski-jump shape).

FIG. 4 is a schematic view showing a monitor screen display of Micro XAM. Screen is displayed on micro xam monitor as shown. (method of measuring dub-off)

FIG. 5 is a schematic sectional view showing an example of “area” in FIG. 4 as viewed from the side. FIG. 5(a) shows “roll-off” shape (in this case, D/O is positive). FIG. 5(b) shows “ski jump” shape (in this case, D/O is negative).

FIG. 6 is a view showing examples of the monitor screen display of Micro XAM.

FIG. 7 is a graph showing a relationship between the dub-off and the outer peripheral glide avalanche obtained in an Example of the present invention, with respect to 65 mm-media.

### BEST EMBODIMENT FOR CARRYING OUT THE PRESENT INVENTION

Hereinbelow, the present invention will be described in detail, with reference to the accompanying drawings as desired. In the following description, “%” and “part(s)” representing a quantitative proportion or ratio are those based on mass, unless otherwise specifically noted.

### (Glass Substrate)

The glass substrate according to the present invention has a chamfer (chamfered) face between the surface (data face) of the substrate for forming thereon a film comprising a magnetic layer, and the outer peripheral end face (straight face), wherein the dub-off on the chamfer face in the radial direction of the outer periphery is 120 Å or less.

### (One Basic Embodiment)

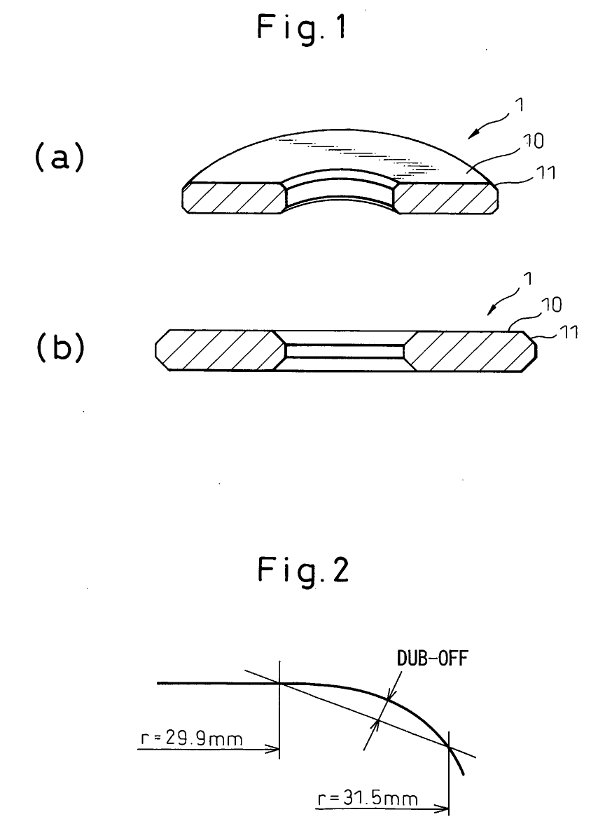

FIG. 1 is a schematic perspective view (a) and a schematic sectional view (b) illustrating one basic embodiment of the glass substrate according to the present invention. FIG. 2 is an enlarged sectional view of the disk outermost edge portion of the glass substrate.

Referring to FIGS. 1 and 2, in the glass substrate according to this embodiment of the present invention, the shape having the dub-off as shown in FIG. 2 is defined between the data surface 10 and the chamfer face 11.

### (Method of Measuring Dub-Off)

In the present invention, the dub-off is 120 Å or less. The dub-off can be advantageously measured by the method shown in Test Example 1 described hereinafter.

If the dub-off exceeds 120 Å, it becomes difficult to obtain a preferred outer peripheral glide avalanche.

### (Glass Material)

The glass substrate for a magnetic disk is attracting attention as a substrate capable of coping with high rigidity and thinning and moreover, making use of the merits such as high impact resistance. The glass material for the substrate is roughly classified into a chemically strengthened glass and a crystallized glass. In either case, the glass material is subjected to a strengthening treatment or a crystallization treatment so as to overcome the defect inherent in the glass, that is, brittleness.

Usually, the presence of a scratch on the glass surface greatly impairs the mechanical strength and from the standpoint of enhancing the disk reliability, a chemically strengthening treatment by ion exchange is applied. More specifically, the glass substrate (original plate) is dipped in an alkali fused salt, and the alkali ion on the glass surface is exchanged with a larger ion in the fused salt, whereby a compression stress strain layer is formed on the glass surface layer and the breaking strength is greatly increased. In the thus chemically strengthened glass substrate, alkali is prevented from dissolving out from the inside of glass. Preferred examples of the glass substrate for HD include an aluminosilicate glass substrate containing Li⁺ and Na⁺, a soda lime glass substrate containing K⁺ and Na⁺, and a crystallized glass.

### (Suitable Glass Material)

The glass material suitably usable in the present invention is not particularly limited, as long as the glass substrate having the above-mentioned specific dub-off can be formed.

In the present invention, the crystallized glass and the strengthened glass both can be suitably used irrespective of the kind of glass. For example, the glass material includes a series of materials called “glass ceramics”, and examples of the commercially available product include the glass ceramic (TS-10X, trade name) produced by OHARA Inc.

### (Process for Producing Glass Substrate)

The process for producing the glass substrate usable in the present invention is not particularly limited, as long as the glass substrate having the above-mentioned specific dub-off can be formed by the process.

### (Magnetic Recording Medium)

The magnetic recording medium according to the present invention is obtained by disposing a magnetic recording layer on the data face of the above-mentioned glass substrate according to the present invention. The method for forming the magnetic recording layer is not particularly limited, as long as the effect of the glass substrate having the above-mentioned specific dub-off according to the present invention is not substantially inhibited.

Hereinbelow, the present invention will be described in more detail with reference to Examples.

### EXAMPLES

### Test Example 1

### (Dub-Off Measurement)

The dub-off was measured by using a measuring instrument (trade name: Micro-Xam, manufactured by ADE Phase Shift Inc.). The method and conditions for the measurement were as follows:

### <Dub-Off Measurement>

Disk diameter: 65 mm

1. Number of sampling pieces: One piece (two sides)/batch

2. Place for measurement: Randomly selected one place and a place 180 degrees apart from the first place (i.e., two places) on each side were measured.

3. Data read

[Table 1]

TABLE 1

| | MAX | MIN | n |
|---|---|---|---|
| Chord MAX | | | 96 |
| Chord MIN | | | 96 |

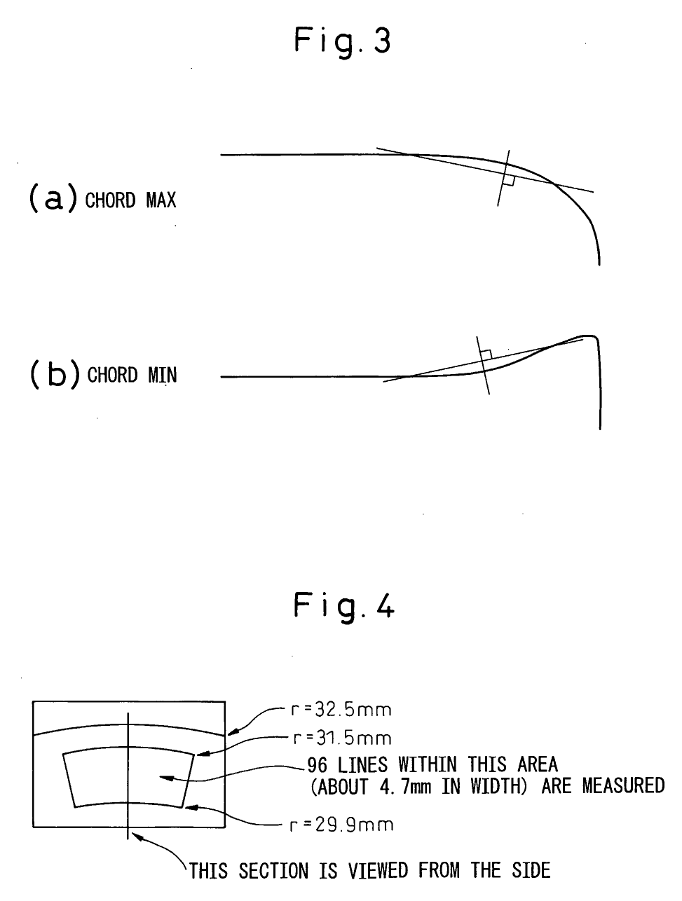

FIG. 3(a) is a schematic sectional view showing “Chord MAX”, i.e., the case (roll-off shape) where the surface is located above the straight line joining the point corresponding to “r=29.9” and the point corresponding to “r=31.5”.

FIG. 3(b) is a schematic sectional view showing “Chord MIN”, i.e., the case (ski jump shape) where the surface is located below the straight line joining the point corresponding to “r=29.9” and the point corresponding to “r=31.5”.

In Table 1 shown above, 96 of n's are present. This is because, in the area (about 5.2 mm×3.6 mm) captured through the lens, an area having a width of about 4.7 mm is divided into 96 segments. The 96 pieces of data are displayed by being embedded in Table 1 above.

When the MAX value of Chord MAX and the MIN value of Chord MIN are displayed in Table 1, the value having the larger absolute value is read out as an indication of the dub-off at that place.

### <Conditions for Dub-Off Measurement>

[Table 2]

TABLE 2

| | | | |
|---|---|---|---|
| measuring apparatus: | Micro XAM | | |
| objective lens: | ×2.5 | intermediate lens: | ×0.62 |
| Disk Diameter: | 65000 μm | Chamfer Length: | 150 μm |
| Inner Fit Radius: | 29900 μm | Outer Fit Radius: | 31500 μm |
| Inner Chord Radius: | 29900 μm | Outer Chord Radius: | 31500 μm |
| DubOff Radius: | 31500 μm | | |

### <Method of Measuring Dub-Off>

An image, such as shown in the schematic diagram of FIG. 4, is displayed on the monitor of the Micro XAM.

In FIG. 4, the area is subjected to 96-line measurement (about 4.7 mm in width). Among the thus obtained numerical values, the value having the largest absolute value is taken as “D/O”.

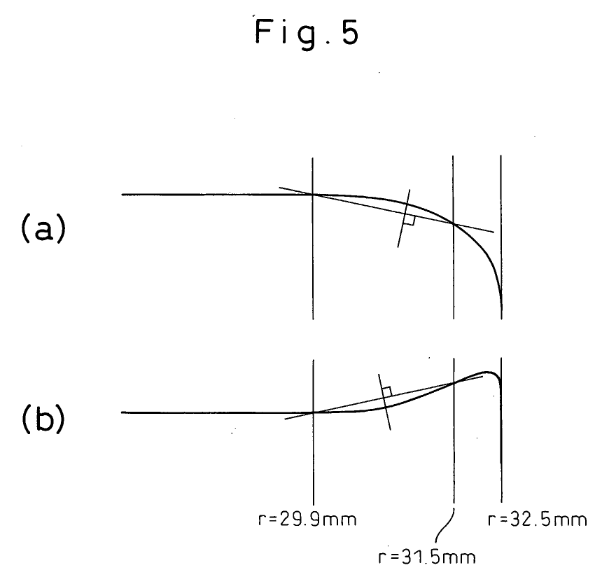

The above area as viewed from the side is shown in the schematic sectional view of FIG. 5.

In the case of FIG. 5(b) (ski jump), the value is actually negative but is evaluated in terms of the absolute value thereof.

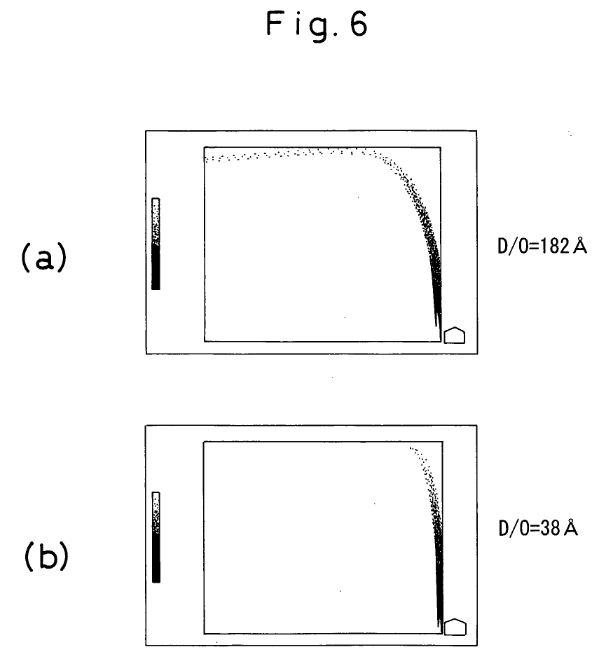

Examples of actually measured images are shown in FIG. 6.

### Example 1

A substrate for a magnetic recording medium was produced by using a crystallized glass obtained from a raw material of SiO₂ 77%, Li₂O 11%, Al₂O₃ 4% and MgO 3%.

In the production of this substrate for a magnetic recording medium, the raw material glass having the above-described composition was melted and mixed at a temperature of about 1,350 to 1,500° C. by using a melting apparatus, and the melt was press-shaped and then cooled to obtain a disk-shaped sheet glass having a diameter of 66 mmφ and a thickness of 1 mm. This sheet glass was heat-treated at 540° C. for about 5 hours to form crystal nuclei and then, crystal growth was allowed to proceed at a temperature of 780° C. for about 2 hours to obtain a crystallized glass. In this crystallized glass, the crystal phases were lithium disilicate and α-quartz, and particles resulting from aggregation of α-quartz were dispersed on the glass.

In the center of this sheet glass, a borehole was formed by using a cylindrical grindstone. Subsequently, the main surfaces of the substrate were subjected to a two-stage lapping process consisting of coarse lapping and precision lapping in a double-face polishing apparatus using diamond pellets, thereby adjusting the thickness and surface roughness of the substrate. Subsequently, the end face on the inner peripheral side facing the borehole of the substrate and the end face on the outer peripheral side were each chamfered with a grindstone by using an internal-external processing apparatus to form a chamfer.

The thus-processed glass substrate was processed for mirror polishing of respective end faces on the inner and outer peripheral sides. Subsequently, the main surfaces of the substrate were finally mirror-finished by using a double-face polishing apparatus (Model 16B, mfd. by SPEEDFAM Co., Ltd.). The polishing process was performed by two-stage polishing of coarse polishing and precision polishing.

In the coarse polishing, a cerium oxide powder-containing abrasive (ROX, produced by Showa Denko K.K.) was used as the abrasive, and a commercially available urethane pad was selected as the polishing pad. In the subsequent precision polishing, a cerium oxide powder-containing abrasive (ROX, produced by Showa Denko K.K.) and a colloidal silica-containing abrasive (Compol, produced by Fujimi Incorporated) were used as the abrasive, and a commercially available suede pad was selected as the polishing pad. In this case, samples of several levels having different outer peripheral dub-off values were prepared by changing the precision polishing conditions so as to provide several precision polishing levels.

The obtained substrate was subjected to brush-scrub cleaning and subsequently to immersion cleaning using an ultrasonic wave in combination to remove deposits on the surface, and then dried with IPA (isopropyl alcohol) vapor to obtain a glass substrate for a magnetic recording medium.

Thereafter, the obtained substrate was subjected to a texturing treatment with the use of a diamond slurry and a non-woven fabric, and then mounted on a sputtering apparatus, and an under film consisting of a chromium alloy and a magnetic film consisting of a cobalt alloy were formed on both surfaces of the substrate by sputtering. Furthermore, a diamond-like carbon film was formed thereon by the CVD process and on this film, Fonblin Z-Tetraol (produced by Solvay Solexis) as a lubricant was coated to produce a magnetic recording medium. The total thickness of the films formed by sputtering was 90 nm, and the thickness of the film formed by CVD was 10 nm.

The outer peripheral glide avalanche of these magnetic recording mediums was evaluated by using a Media Defect Evaluating Apparatus mfd. by Hitachi High-Technologies Corporation.

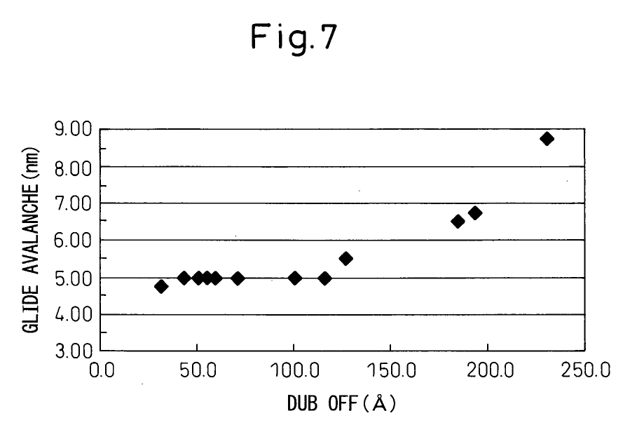

The thus obtained evaluation results are shown in the following Table 3 and FIG. 7. As shown in Table 3 and FIG. 7, it was found that the samples having a dub-off of 120 Å or less showed an outer peripheral glide avalanche of 5 nm or less, while the value of the outer peripheral glide avalanche was steeply increased when the dub-off value exceeded 120 Å.

TABLE 3
65 mm media G.A. vs Duboff

| No. | G.A. (nm) | Dub off (Å) |
|---|---|---|
| 1 | 4.75 | 31.2 |
| 2 | 5.00 | 43.5 |
| 3 | 5.00 | 51.0 |
| 4 | 5.00 | 55.7 |
| 5 | 5.00 | 59.6 |
| 6 | 5.00 | 71.3 |
| 7 | 5.00 | 101.1 |
| 8 | 5.00 | 116.3 |
| 9 | 5.50 | 127.1 |
| 10 | 6.50 | 184.5 |
| 11 | 6.75 | 194.0 |
| 12 | 8.75 | 230.3 |

### INDUSTRIAL APPLICABILITY

As described above, the present invention provides a glass substrate for a magnetic recording medium which can achieve a small preferred outer peripheral glide avalanche so as to achieve high recording density, and also provides a magnetic recording medium using such a glass substrate.

1. A glass substrate for a magnetic recording medium, having a chamfer (chamfered) face between the surface (data face) of the substrate for forming thereon a film comprising a magnetic layer, and the outer peripheral end face (straight face) of the substrate, wherein the outer peripheral chamfer face has a dub-off of 120 Å or less in the radial direction.

2. A magnetic recording medium, comprising:
a glass substrate according to claim 1, and
a magnetic recording layer disposed on the data face of the glass substrate.
